(19) United States
(12) Patent Application Publication
(10) Pub. No.: US 2018/0253599 A1
(43) Pub. Date: Sep. 6, 2018

(54) DOCUMENT IMAGE PROCESSING AND ADVANCED CORRELATION OF IMAGE DATA

(71) Applicant: BANK OF AMERICA CORPORATION, Charlotte, NC (US)

(72) Inventor: Tami Marie Shepard, Battle Ground, WA (US)

(21) Appl. No.: 15/449,319

(22) Filed: Mar. 3, 2017

(51) Int. Cl. G06K 9/00; G06K 9/18; G06K 9/62; G06Q 40/02

(52) U.S. Cl. CPC G06K 9/00469; G06K 9/00161; G06K 9/00483; G06K 2209/27; G06K 9/6281; G06Q 40/02; G06K 2209/01; G06K 9/186

(57) ABSTRACT

Embodiments of the invention include systems, methods, and computer-program products for optical character recognition image data extraction from resource documents. The invention includes capacity for optical character recognition of a majority of data on a resource document. A request for image data advanced correlation is received and processed. The advanced correlation may include payer/payee analysis, misappropriation detection for resource documents, resource document duplicate detection, testing applications, and image cash letter analysis. The invention may code the image data via qubits for quantum optimization and advanced correlation of the image data.

### BACKGROUND

Entities typically receive large volumes of documents from vendors, customers, or employees on any given day. Each document is typically reconciled upon receiving. In this way, specific characteristics of a document are matched to a corresponding reconciliation processing. Image processing to a match further includes the extraction and processing of image data.

### BRIEF SUMMARY

Embodiments of the present invention address the above needs and/or achieve other advantages by providing apparatuses (e.g., a system, computer program product and/or other devices) and methods for document image processing and advanced correlation of image data generated. In this way, the system is necessarily rooted in computer technology and improves the generation of data from physical documents.

Entities, such as financial institutions may receive paper resource documents, such as checks or the like. These paper documents are converted into image documents. In some embodiments, entities may have billions of check images that are archived every year, and once the image statement and/or image cash letter is created the check image data is stored in an archive for 7-20 years. Beyond signature verification, there are other ways to leverage that image data. As such, the system performs document image processing and utilizes a quantum computer for advanced correlation of the image data. For example the system may perform payer/payee analysis. Thus, the system may identify the use of checks a user drafted, the payee of the checks drafted, and the like and generate a user profile or pattern associated with the user check drafting and receiving. Thus, the system may suggest products/services to the user based on the data analytics performed.

In some embodiments, the system may provide additional misappropriation detection for resource documents. Typically misappropriation detection can include a random search of types of resources that see the most misappropriation and a review of those resource instruments. The system may, using a quantum optimizer, run the image data through an algorithmic misappropriation detection engine against all image data items rather than a select few.

In some embodiments, the system may be utilized for identification of resource document duplicate detection. Historically, duplicate detection has been a very labor intensive process. Situations where there are duplicates require an operator to review. The system may be able to direct the image data to the quantum optimizer to identify duplicates without operator review. For example, the system may review the 1000 ten dollar rebate checks that have the same account and/or serial number and the system may recognize that these are not duplicate checks based on identification of payee and the like that are otherwise not identified by standard optical character recognition (OCR) systems.

In some embodiments, the system may be used for testing purposes. In this way, the quantum optimizer could include a scrubber that could clear off user data from a check image, so that a real check could be used for image quality testing and analysis. Using this scrubber would further allow for high volume testing. A scrubber could be built and not be limited to small amounts of data (due to the processing required for the scrub), thus giving the image quality and testing more accurate testing data.

In some embodiments, the system may provide image cash letter analysis. Entities working with resource documents, especially financial institutions receive resource documents that are in transit, or belong to a different issuing institution. The system may be able to scan these outgoing transit resource documents and perform data analytics on them. Using this scan, the quantum optimizer may determine resource document trends for users across multiple entities.

The invention may identify indicia on resource document, such as a check. The system may scan the resource document and perform optical character recognition to identify the various indicia on the resource document. The indicia includes data related to the payor, payment accounts, or payee. An X and Y axis of the resource document is generated and coordinates for the various indicia are identified and stored.

In some embodiments, the keying of resource documents may identify exceptions in the processing of the resource document. The exceptions may include one or more irregularities such as bad Micr line reads, outdated check stock, or misrepresentative indicia points on a resource document that may result in a failure to match the check to an account for processing. Payment instrument or resource document exception processing allows decisions for exception processing to systematically resolve exceptions.

In some embodiments, the system may receive images of resource documents from one or more sources. The resource documents may be received from within an entity, from other financial institutions, or the like. In some embodiments, the documents include images of checks or other financial documents captured by an account holder or other entity. From the received resource documents or payment instruments, the system may detect an X and Y axis of the resource document as well as coordinates associated with various indicia. This indicia may include any data point, written or printed, on the front or back of the resource document. The resource documents may include a myriad of financial documents, including but not limited to checks, lease documents, mortgage documents, deposit slips, payment coupons, receipts, general ledger tickets, or the like. In the present invention, once the resource document is received, the invention may extract data from the resource document for various advanced correlation analytics.

Embodiments of the invention relate to systems, methods, and computer program products for resource document image extraction and advanced correlation of image data, the invention comprising: a classical computer apparatus comprising and a quantum optimizer in communication with the classical computer apparatus, wherein the correlation application is configured for: receiving one or more resource documents and perform optical character recognition on the one or more resource documents to generate image data; storing the generated image data and additional image data; receiving request for advanced correlation of image data; identifying image data from the received one or more resource documents necessary for the advanced correlation of image data; sending a communication to the quantum optimizer for the advanced correlation of image data; wherein the quantum optimizer is configured for: performing further optical character recognition to identify and extract the additional image data; analyzing the image data received from the correlation application to generate the advanced correlation of image data; and coding the advance correlation for classical computer apparatus receiving and presentation to a user.

In some embodiments, an advanced correlation of image data includes payer/payee analysis, wherein payer/payee analysis includes identifying a use of the one or more resource documents drafted by the payor and generating a payor profile patterning payor use of one or more resource documents and generating suggested financial products or services based on the patterning.

In some embodiments, an advanced correlation of image data includes detection of resource document processing duplicates, wherein detection of resource document processing duplicates comprises the quantum optimizer analyzing the account, serial number, and hand written portions to identify exact duplicates between image data from the one or more resource documents received.

In some embodiments, an advanced correlation of image data includes generating test resource documents for resource document processing, wherein the quantum optimizer includes a scrubber network generates a scrubbed document that clears all data off of a received one or more resource documents except for the background of the document, wherein the scrubbed document is re-positioned in the process with fake information on the scrubbed document for testing the resource document processing.

In some embodiments, an advanced correlation of image data includes generating an image cash letter analysis, wherein the image cash letter analysis includes scanning outgoing transit resource documents and perform data analytics to determine resource document trends for third party payers across multiple entities.

In some embodiments, the correlation application performs optical character recognition on the one or more resource documents including recognition of printed information on the resource documents.

In some embodiments, the quantum optimizer performs further optical character recognition to identify and extract written information from the resource documents, wherein the quantum optimizer identifies and predicts the letters of the written information from the resource documents.

In some embodiments, the request for advanced correlation of image data further comprises a request for payer/payee analysis, misappropriation detection, resource document duplicate detection, testing, or image cash letter analysis.

In some embodiments, receiving one or more resource documents and perform optical character recognition on the one or more resource documents to generate image data further comprises generate a grid of the resource document and identifying an axis coordinates for one or more parameter points of the one or more resource document, wherein the axis coordinates are an X and Y axis point based on the generated grid of the one or more resource documents that identify one or more outside parameter points for each of a front and a back of the resource document.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a processing and advanced correlation system environment, in accordance with one embodiment of the present invention;

FIG. 2 is a diagram of a quantum optimizer, in accordance with embodiments of the present invention;

FIG. 3 is a flowchart illustrating the utilization of quantum computer within document processing and advanced correlation, in accordance with one embodiment of the present invention;

FIG. 4 provides a process flow illustrating document processing and advance correlation of image data, in accordance with one embodiment of the present invention;

FIG. 5 illustrates an exemplary image of a resource document, in accordance with one embodiment of the present invention;

FIG. 6 provides an exemplary template of a resource document, in accordance with one embodiment of the present invention; and

FIG. 7 provides a process flow illustrating advanced correlation of image data, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise.

As used herein, a “document,” “resource instrument,” “resource document,” “negotiable instrument,” “financial document,” or “check” may also refer to a myriad of resource document documents, including but not limited to a lease document, checks, a mortgage document, a deposit slip, a payment coupon, a receipt, general ledger tickets, payments, deposits, customer correspondence, or the like. In some embodiments, “resource document” may exist as a physical item printed on paper or other medium. In other embodiments, the check may exist electronically. Furthermore, “resource document” may also refer to records associated with government data, legal data, identification data, and the like. The “resource document” may also include supporting documents supportive of the myriad of resource document documents, including but not limited to a lease document, checks, a mortgage document, a deposit slip, a payment coupon, a receipt, general ledger tickets, payments, deposits, customer correspondence, or the like. Although the disclosure is directed to resource documents, it will be understood that non-financial records such as social communications, advertising, blogs, opinion writing, and the like may also be applicable to the disclosure presented herein. In cases were non-financial records are use, it will be understood that personal information, such personal identifying information, account numbers, and the like, can be removed from the documents before they are released. For example, if a coupon or product review is to be used in advertising, personal information associated with such records will be removed before the advertising is presented to the public. The data of the financial records or non-financial records may be provided in a wide variety formats including, paper records, electronic or digital records, video records, audio records, and/or combinations thereof In some embodiments, the “resource document” may be referred to in examples as a check or the like.

Furthermore, the term “image lift data” or “data lift” may refer to the process of lifting one or more areas/elements of a document and storing those areas as metadata without storing the entire document as an image file. Furthermore, in some embodiments the term indicia may refer to any text, illustration, writing, or the like on the resource document. In this way, indicia may include any information in a grouping on a resource document, such as check information, such as contact information, the payee, the memo description, the account number, routing number, user or customer account, the date, the check number, the amount of the check, the signature, or the like. In some embodiments, the indicia information may comprise text. In other embodiments, the indicia may comprise an image.

In some embodiments, the system may receive images of resource documents from one or more sources. The resource documents may be received from within an entity, from other financial institutions, or the like. In some embodiments, the documents include images of checks or other financial documents captured by an account holder or other entity. From the received resource documents or payment instruments, the system may detect an X and Y axis of the resource document as well as coordinates associated with various indicia. This indicia may include any data point, written or printed, on the front or back of the resource document. The resource documents may include a myriad of financial documents, including but not limited to checks, lease documents, mortgage documents, deposit slips, payment coupons, receipts, general ledger tickets, or the like.

Entities, such as financial institutions may receive paper resource documents, such as checks or the like. These paper documents are converted into image documents. In some embodiments, entities may have billions of check images that are archived every year, and the image statement and/or image cash letter is created the check image data is stored in an archive for 7-20 years. In this way, the image statement and/or image cash letter are stored in the archive upon receiving the data. Beyond signature verification, there are other ways to leverage that image data. As such, the system performs document image processing and utilizes a quantum computer for advanced correlation of the image data. For example the system may perform payer/payee analysis. Thus, the system may identify the use of checks a user drafted, the payee of the checks drafted, and the like and generate a user profile or pattern associated with the user check drafting and receiving. Thus, the system may suggest products/services to the user based on the data analytics performed.

In some embodiments, the system may provide additional misappropriation detection for resource documents. Typically misappropriation detection can include a random search of types of resources that see the most misappropriation and a review of those resource instruments. The system may, using a quantum optimizer, run the image data through an algorithmic misappropriation detection engine against all image data items rather than a select few.

In some embodiments, the system may be utilized for identification of resource document duplicate detection. Historically, duplicate detection has been a very labor intensive process. Situations where there are duplicates require an operator to review. The system may be able to direct the image data to the quantum optimizer to identify duplicates without operator review. For example, the system may review the 1000 ten dollar rebate checks that have the same account and/or serial number and the system may recognize that these are not duplicate checks based on identification of payee and the like that are otherwise not identified by standard optical character recognition (OCR) systems.

In some embodiments, the system may be used for testing purposes. In this way, the quantum optimizer could include a scrubber that could clear off user data from a check image, so that a real check could be used for image quality testing and analysis. Using this scrubber would further allow for high volume testing. A scrubber could be built and not be limited to small amounts of data (due to the processing required for the scrub), thus giving the image quality and testing more accurate testing data.

In some embodiments, the system may provide image cash letter analysis. Entities working with resource documents, especially financial institutions receive resource documents that are in transit, or belong to a different issuing institution. The system may be able to scan these outgoing transit resource documents and perform data analytics on them. Using this scan, the quantum optimizer may determine resource document trends for users across multiple entities.

As used herein, a quantum computer is any computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2ⁿ states simultaneously. By comparison, a classical computer can only be in one of the 2ⁿ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. No. 9,400,499, U.S. Pat. No. 9,207,672, each of which is incorporated herein by reference in its entirety.

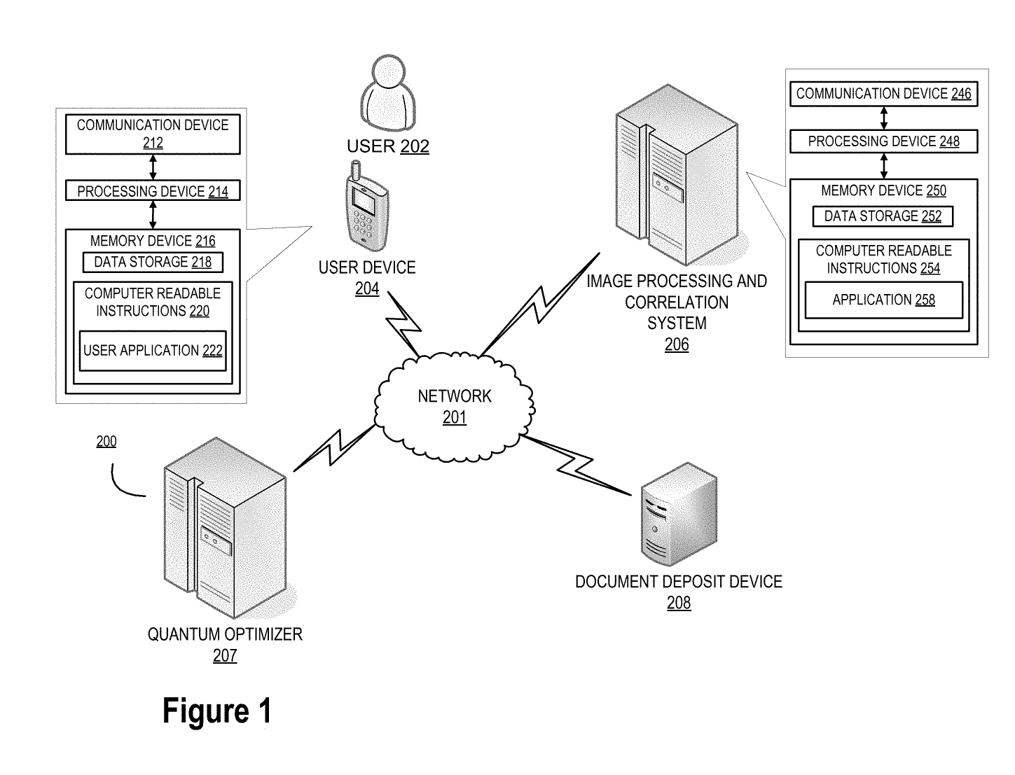

FIG. 1 illustrates a processing and advanced correlation system environment 200, in accordance with embodiments of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of generating logic code for lineage identification and tracking of resource inception, use, and current location.

As illustrated in FIG. 1, the document deposit device 208 is operatively coupled, via a network 201 to the user device 204, quantum optimizer 207, and to the image processing and correlation system 206. In this way, the document deposit device 208 can send information to and receive information from the user device 204, quantum optimizer 207, and the image processing and correlation system 206.

FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that possesses or has possessed a resource instrument or document. In some embodiments, the user 202 may have completed a transaction using a document, drafting a resource document, or the like. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the image processing and correlation system 206, the check deposit device 208, and the quantum optimizer 207. As such, the communication device 212 generally comprises a modem, server, or other device for communicating with other devices on the network 201. The user device 204 comprises computer-readable instructions 220 and data storage 218 stored in the memory device 216, which in one embodiment includes the computer-readable instructions 220 of a user application 222.

As further illustrated in FIG. 1, the image processing and correlation system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the check deposit device 208, the quantum optimizer 207, and the user device 204. As such, the communication device 246 generally comprises a modem, server, or other device for communicating with other devices on the network 201.

As further illustrated in FIG. 1, the image processing and correlation system 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the image processing and correlation system 206 the memory device 250 stores an application 258. Furthermore, the image processing and correlation system 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more check deposit device 208, quantum optimizer 207, and/or user device 204.

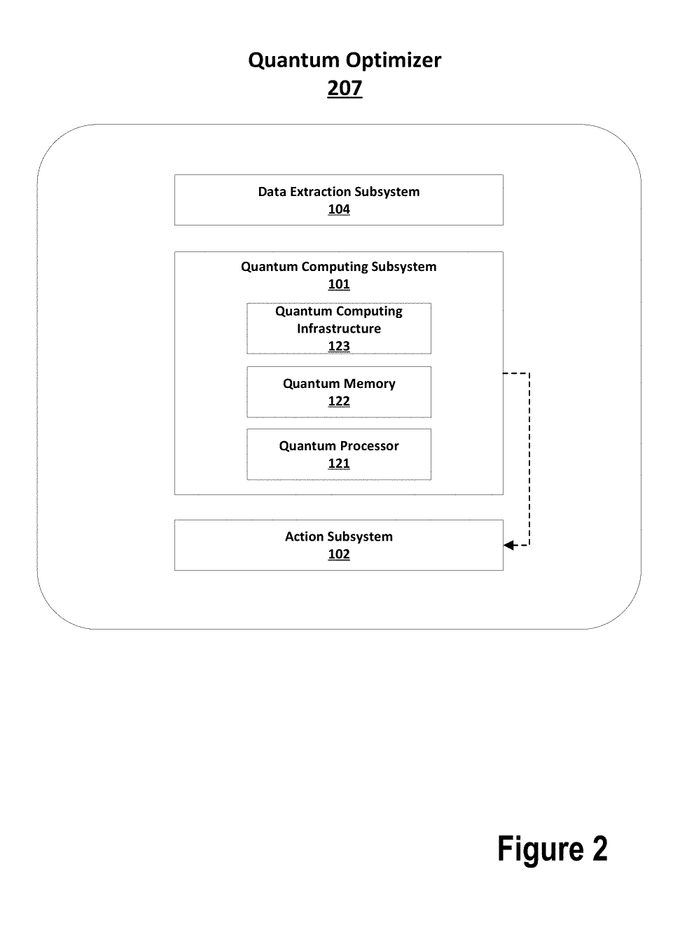

In some embodiments, the image processing and correlation system 206 via the application may communicate with the quantum optimizer 207 to allow for quantum processing of data. In this way, the application 258 may provide document image processing and advanced correlation of image data. As such, the application 258 may manipulate standard computer data and triggers a communication of that data to a quantum optimizer 207 for required quantum analytics. The application 258 then manipulates the data for subsequent conversion to general computer coding. In some embodiments, the application 258 may identify the completion of a transaction using the resource instrument by using the computation processing of completed transactions from a financial institution, user device 204, the check deposit device 208, or the like. As illustrated in FIG. 1, the quantum optimizer 207 is connected to at least the image processing and correlation system 206. The quantum optimizer is described in more detail below with respect to FIG. 2. The quantum optimizer 207 may be associated with one or more entities. In this way, the quantum optimizer 207 may be associated with a third party, a financial institution, or the like.

As illustrated in FIG. 1, the document deposit device 208 is connected to the quantum optimizer 207, user device 204, and image processing and correlation system 206. In some embodiments, the document deposit device 208 may be a third party system separate from the image processing and correlation system 206. The document deposit device 208 has the same or similar components as described above with respect to the user device 204 and the image processing and correlation system 206. While only one document deposit device 208 is illustrated in FIG. 1, it is understood that multiple document deposit device 208 may make up the system environment 200.

The document deposit device 208 includes a communication device and an image capture device (e.g., a camera) communicably coupled with a processing device, which is also communicably coupled with a memory device. The processing device is configured to control the communication device such that the document deposit device 208 communicates across the network with one or more other systems. The processing device is also configured to access the memory device in order to read the computer readable instructions, which in some embodiments includes a capture application and an online banking application. The memory device also includes a datastore or database for storing pieces of data that can be accessed by the processing device. The document deposit device 208 may be a mobile device of the user, a bank teller device, a third party device, an automated teller machine, a video teller machine, or another device capable of capturing a check image.

In some embodiments, a capture application, the online banking application, and the transaction application interact with the OCR engines to receive or provide financial record images and data, detect and extract financial record data from financial record images, analyze financial record data, and implement business strategies, transactions, and processes. The OCR engines and the client keying application may be a suite of applications for conducting OCR and/or a computer system associated with a representative for keying in aspects of the received resource document.

It is understood that the servers, systems, and devices described herein illustrate one embodiment of the invention. It is further understood that one or more of the servers, systems, and devices can be combined in other embodiments and still function in the same or similar way as the embodiments described herein. The document deposit device 208 may generally include a processing device communicably coupled to devices as a memory device, output devices, input devices, a network interface, a power source, one or more chips, and the like. The document deposit device 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the document deposit device 208 described herein.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2ⁿ states simultaneously. By comparison, a classical computer can only be in one of the 2ⁿ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations.

FIG. 2 is a schematic diagram of an exemplary Quantum Optimizer 207 that can be used in parallel with a classical computer to solve optimization problems. The Quantum Optimizer 207 is comprised of a Data Extraction Subsystem 104, a Quantum Computing Subsystem 101, and an Action Subsystem 105. As used herein, the term “subsystem” generally refers to components, modules, hardware, software, communication links, and the like of particular components of the system. Subsystems as contemplated in embodiments of the present invention are configured to perform tasks within the system as a whole.

As depicted in FIG. 2, the Data Extraction Subsystem 104 communicates with the network to extract data for optimization. It will be understood that any method of communication between the Data Extraction Subsystem 104 and the network is sufficient, including but not limited to wired communication, Radiofrequency (RF) communication, Bluetooth WiFi, and the like. The Data Extraction Subsystem 104 then formats the data for optimization in the Quantum Computing Subsystem.

As further depicted in FIG. 2, the Quantum Computing Subsystem 101 comprises a Quantum Computing Infrastructure 123, a Quantum Memory 122, and a Quantum Processor 121. The Quantum Computing Infrastructure 123 comprises physical components for housing the Quantum Processor 121 and the Quantum Memory 122. The Quantum Computer Infrastructure 123 further comprises a cryogenic refrigeration system to keep the Quantum Computing Subsystem 101 at the desired operating temperatures. In general, the Quantum Processor 121 is designed to perform adiabatic quantum computation and/or quantum annealing to optimize data received from the Data Extraction Subsystem 104. The Quantum Memory 122 is comprised of a plurality of qubits used for storing data during operation of the Quantum Computing Subsystem 101. In general, qubits are any two-state quantum mechanical system. It will be understood that the Quantum Memory 122 may be comprised of any such two-state quantum mechanical system, such as the polarization of a single photon, the spin of an electron, and the like.

The Action Subsystem 102 communicates the optimized data from the Quantum Computing Subsystem 101 over the network. It will be understood that any method of communication between the Data Extraction Subsystem 104 and the network is sufficient, including but not limited to wired communication, Radiofrequency (RF) communication, Bluetooth®, WiFi, and the like.

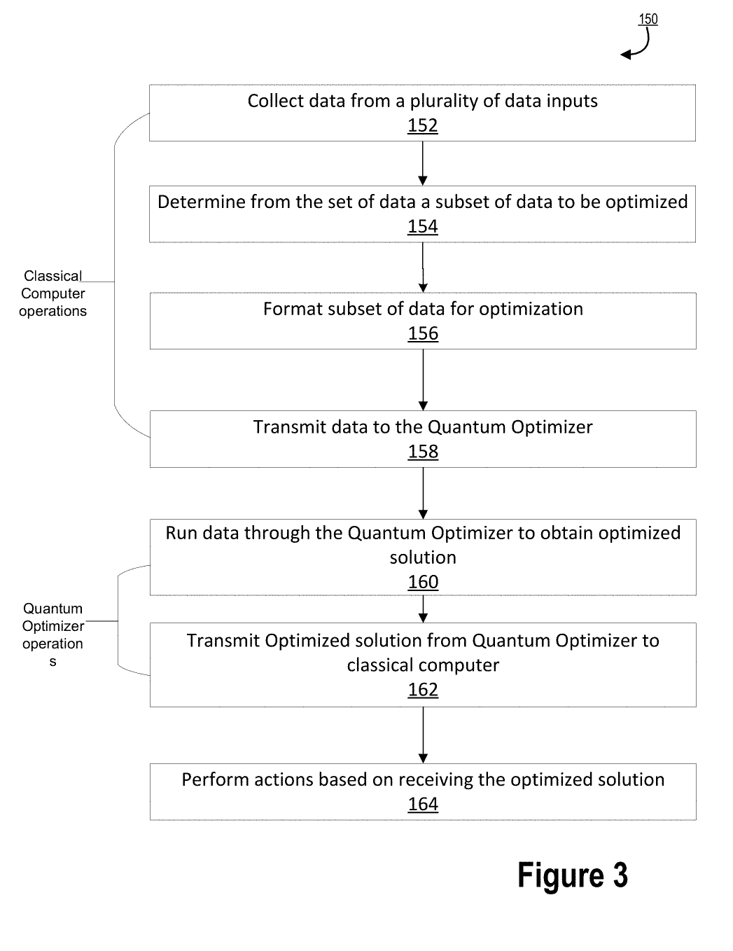

FIG. 3 is a high level process flow of utilization of quantum computer within a lineage identification framework 150, in accordance with some embodiments of the invention. As depicted in FIG. 3, a classical computer begins the process at step 152 by collecting data from a plurality of inputs. At step 154, the classical computer then determines from the set of data collected at step 152 a subset a data to be optimized. The classical computer then formats the subset of data for optimization at step 156. At step 158, the classical computer transmits the formatted subset of data to the Quantum Optimizer. The Quantum Optimizer runs the data to obtain the optimized solution at 160. The Quantum Optimizer then transmits the optimized data back to the classical computer at step 162. Finally, the classical computer can perform actions based on receiving the optimized solution at step 164.

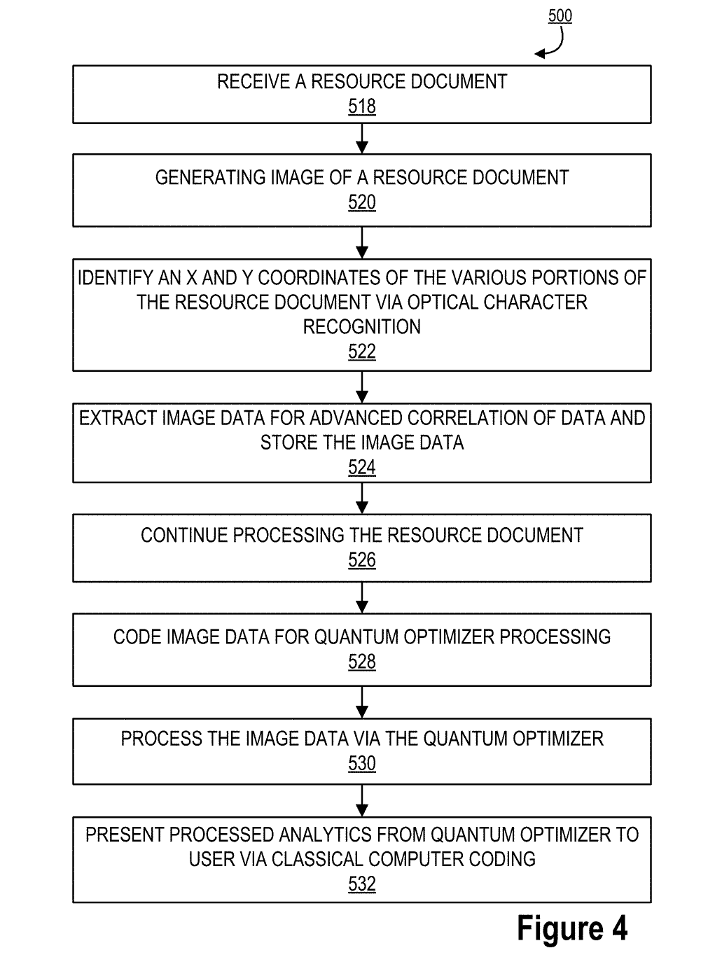

FIG. 4 provides a process flow illustrating document processing and advance correlation of image data 500, in accordance with one embodiment of the present invention. As illustrated in block 518, the process 500 is initiated by receiving one or more paper resource documents. In some embodiments, the resource documents may be received directly from a customer at a financial institution associated with the entity. In other embodiments, the system may receive the resource documents as transit documents being passed through the entity associated with the system. In some embodiments, the received resource document may be a digital file or digital data document.

As illustrated in block 520, the process 500 continues by generating an image of the resource document. The image generated may be one or more of a check, other document, payment instrument, and/or financial record. In some embodiments, the image of the check may be received by a specialized apparatus associated with the financial institution (e.g. a computer system) via a communicable link to a user's mobile device, a camera, an Automated Teller Machine (ATM) at one of the entity's facilities, a second apparatus at a teller's station, another financial institution, or the like. In other embodiments, the apparatus may be specially configured to capture the image of the check for storage and exception processing. The system may then lift indicia in the form of data off of the check using optical character recognition (OCR). The OCR processes enables the system to convert text and other symbols in the check images to other formats such as text files and/or metadata, which can then be used and incorporated into a variety of applications, documents, and processes. In some embodiments, OCR based algorithms used in the OCR processes incorporate pattern matching techniques. For example, each character in an imaged word, phrase, code, or string of alphanumeric text can be evaluated on a pixel-by-pixel basis and matched to a stored character. Various algorithms may be repeatedly applied to determine the best match between the image and stored characters.

At least one OCR process may be applied to each of the check images or some of the check images. The OCR processes enables the system to convert text and other symbols in the check images to other formats such as text files and/or metadata, which can then be used and incorporated into a variety of applications, documents, and processes. In some embodiments, OCR based algorithms used in the OCR processes incorporate pattern matching techniques. For example, each character in an imaged word, phrase, code, or string of alphanumeric text can be evaluated on a pixel-by-pixel basis and matched to a stored character. Various algorithms may be repeatedly applied to determine the best match between the image and stored characters. In some embodiments, the OCR process includes identifying location fields for determining the position of data on the check image. The location fields or indicia are identified in the OCR by identifying an X and Y coordinates of the indicia on the check. Based on the position of the data using the X and Y coordinates, the system can identify the type of data in the location fields to aid in character recognition. For example, an OCR engine may determine that text identified in the upper right portion of a check image corresponds to a check number. The location fields can be defined using any number of techniques.

In addition to OCR processes, the system can use other techniques such as image overlay to locate, identify, and extract data from the check images. In other embodiments, the system uses the magnetic ink character recognition (MICR) to determine the position of non-data (e.g., white space) and data elements on a check image. For example, the MICR of a check may indicate to the system that the received or captured check image is a business check with certain dimensions and also, detailing the location of data elements, such as the check amount box or payee line. In such an instance, once the positions of this information is made available to the system, the system will know to capture any data elements to the right or to the left of the identified locations or include the identified data element in the capture. This system may choose to capture the data elements of a check in any manner using the information determined from the MICR number of the check.

After the successful retrieval or capture of the image of the check, the process 500 may continue by identifying an X and Y coordinates for the various portions of the resource document via OCR as illustrated in block 522. In this way, each indicia associated with the resource document, such as data related to the payor, payment accounts, or payee may be identified with an X and Y axis value relative to the resource document. As such the Y axis may be a vertical axis associated with a vertical portion of the resource document and the X axis may be a horizontal axis associated with the horizontal portion of the resource document. Each axis is plotted with one or more numbers associated with steps up or across the axis. Each number in correlation with the opposing axis number generates a coordinate associated with that particular point on the resource document. In this way, the X and Y axis generation allows for mapping of coordinates of various indicia on the resource document. The apparatus may capture individual pieces of check information from the image of the check as indicia and in metadata form. In some embodiments, the check information may be text. In other embodiments, the check information may be an image processed into a compatible data format.

In some embodiments, the system may store the check information and corresponding coordinate data for each element or indicia identified on the check. After the image of the check is processed, the apparatus may store the coordinates and collected check information in a compatible data format. In some embodiments, the check information may be stored as metadata. As such, individual elements of the check information may be stored separately, and may be associated with each other via metadata. In some embodiments, the individual pieces of check information may be stored together. In some embodiments, the apparatus may additionally store the original image of the check immediately after the image of the check is received.

As illustrated in block 524, the process 500 continues by extracting image data for advanced correlation of data. The system may also store the extracted image data. In some embodiments, standard OCR may not be able to capture all of the data on the resource document including the hand written portions, such as the signature, payee, or the like. In this way, the system may utilize the quantum optimizer to perform the OCR and to extract data. Once extracted the data may be correlated together and stored in a format that is readable by the quantum optimizer.

Next, once the image data is extracted, the system may continue to process the resource documents, as illustrated in block 526. As such, the system may allow the resource documents to be continued to be processed to the appropriate accounts or the like for reconciliation.

As illustrated in block 528, the process 500 continues by coding image data for the quantum optimizer processing. In this way, the image data is coded for the use in the quantum optimizer. As such, a user may be able to request one or more advanced correlation of the image data for analytics. As such, using the quantum optimizer may be able to perform payer/payee analysis, additional misappropriation detection for resource documents, identification of resource document duplicate detection, used for testing purposes, and image cash letter analysis.

Next, as illustrated in block 530, the process 500 continues by transmitting the image data and processing the image data via the quantum optimizer. In this way, the quantum optimizer may be able to perform payer/payee analysis, additional misappropriation detection for resource documents, identification of resource document duplicate detection, used for testing purposes, and image cash letter analysis.

In some embodiments, the quantum optimizer performs payer/payee analysis. In some embodiments, entities may have billions of check images that are archived every year and the system performs document image processing and utilizes a quantum computer for advanced correlation of the image data. Thus, the system may identify the use of checks a user drafted, the payee of the checks drafted, and the like and generate a user profile or pattern associated with the user check drafting and receiving. Thus, the system may suggest products/services to the user based on the data analytics performed.

In some embodiments, the quantum optimizer may provide additional misappropriation detection for resource documents. Typically misappropriation detection can include a random search of types of resources that see the most misappropriation and a review of those resource instruments. The quantum optimizer may run the image data through an algorithmic misappropriation detection engine against all image data items rather than a select few.

In some embodiments, the quantum optimizer may be utilized for identification of resource document duplicate detection. Historically, duplicate detection has been a very labor intensive process. Situations where there are duplicates require an operator to review. The system may be able to direct the image data to the quantum optimizer to identify duplicates without operator review. For example, the system may review the 1000 ten dollar rebate checks that have the same account and/or serial number and the system may recognize that these are not duplicate checks based on identification of payee and the like that are otherwise not identified by standard OCR systems.

In some embodiments, the quantum optimizer may be used for testing purposes. In this way, the quantum optimizer could include a scrubber that could clear off user data from a check image, so that a real check could be used for image quality testing and analysis. Using this scrubber would further allow for high volume testing. A scrubber could be built and not be limited to small amounts of data (due to the processing required for the scrub), thus giving the image quality and testing more accurate testing data.

In some embodiments, the quantum optimizer may provide image cash letter analysis. Entities working with resource documents, especially financial institutions receive resource documents that are in transit, or belong to a different issuing institution. The system may be able to scan these outgoing transit resource documents and perform data analytics on them. Using this scan, the quantum optimizer may determine resource document trends for users across multiple entities.

Next, as illustrated in block 532, the process 500 continues by presenting the processed analytics from the quantum optimizer to the user via classical computer coding. As such, the user may receive the analytics to perform payer/payee analysis, additional misappropriation detection for resource documents, identification of resource document duplicate detection, used for testing purposes, and image cash letter analysis. The system may present the user with a user interface with these analytics via an interactive user interface for selection of and input to the quantum optimizer of the analytics for a request for the analytics.

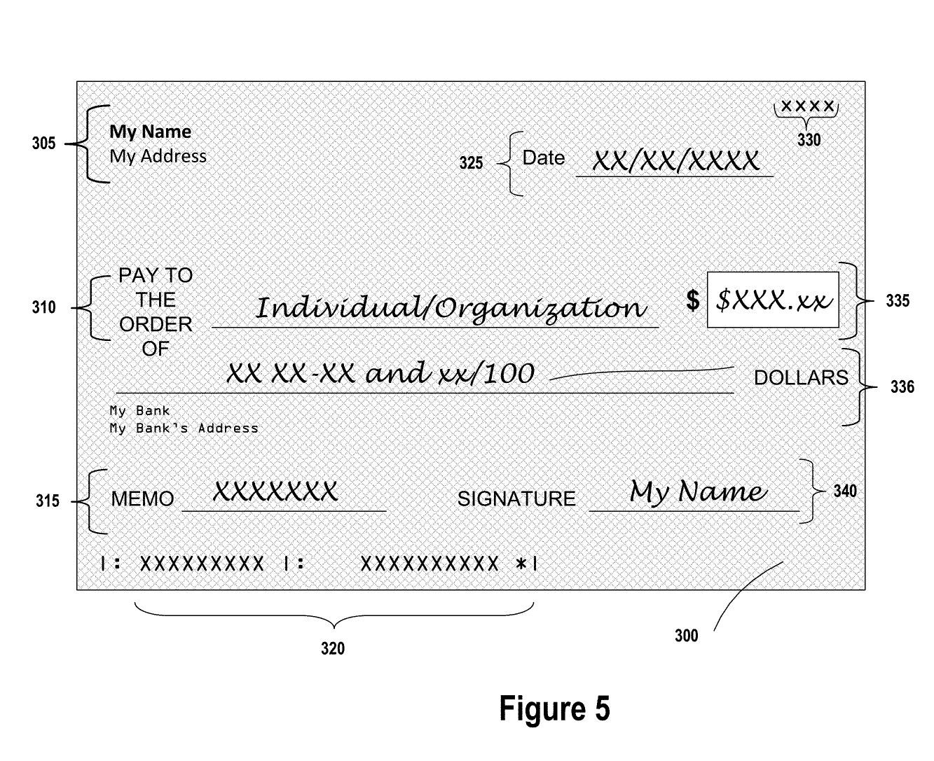

FIG. 5 illustrates an exemplary image of a negotiable instrument 300, in accordance with one embodiment of the present invention. The check images comprise the front portion of a check, the back portion of a check, or any other portions of a check. In cases where there are several checks piled into a stack, the multiple check images may include, for example, at least a portion of each of the four sides of the check stack. In this way, any text, numbers, or other data provided on any side of the check stack may also be used in implementing the process. In some embodiments the system may receive financial documents, payment instruments, checks, or the likes.

In some embodiments, each of the check images comprises indicia that includes financial record data. The financial record data includes dates financial records are issued, terms of the financial record, time period that the financial record is in effect, identification of parties associated with the financial record, payee information, payor information, obligations of parties to a contract, purchase amount, loan amount, consideration for a contract, representations and warranties, product return policies, product descriptions, check numbers, document identifiers, account numbers, merchant codes, file identifiers, source identifiers, and the like.

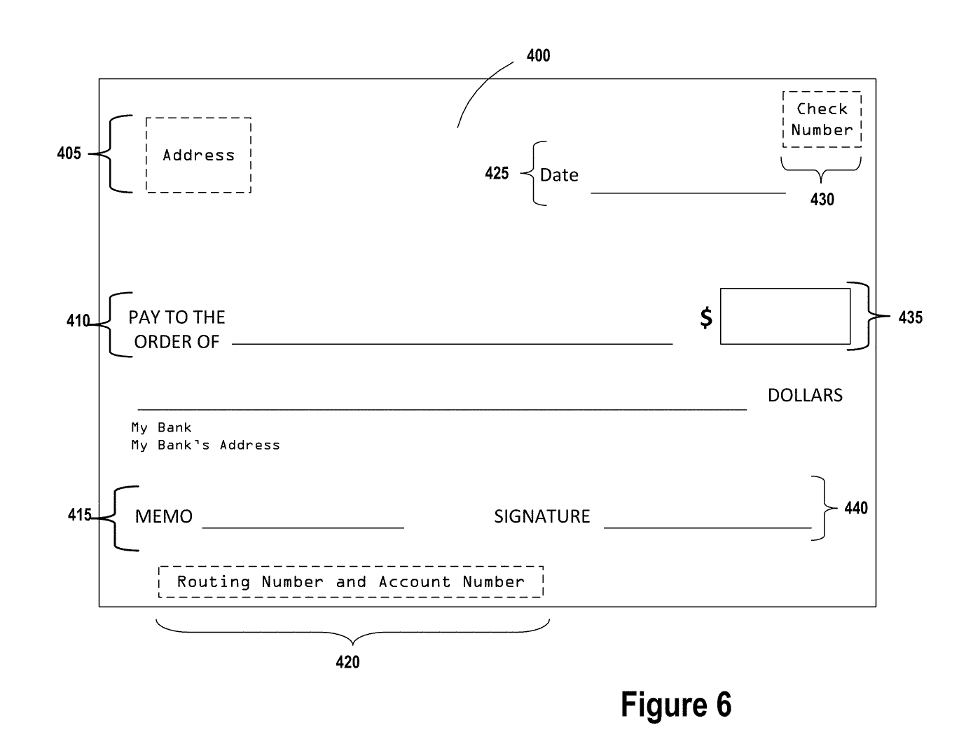

Although check images are illustrated in FIG. 5 and FIG. 6, it will be understood that any type of financial record image or resource document image may be received. Exemplary check images include PDF files, scanned documents, digital photographs, and the like. At least a portion of each of the check images, in some embodiments, is received from a financial institution, a merchant, a signatory of the financial record (e.g., the entity having authority to endorse or issue a financial record), and/or a party to a financial record. In other embodiments, the check images are received from image owners, account holders, agents of account holders, family members of account holders, financial institution customers, payors, payees, third parties, and the like. In some embodiments, the source of at least one of the checks includes an authorized source such as an account holder or a third party financial institution. In other embodiments, the source of at least one of the checks includes an unauthorized source such as an entity that intentionally or unintentionally deposits or provides a check image to the system of process.

In some embodiments, a customer or other entity takes a picture of a check at a point of sales or an automated teller machine (ATM) and communicates the resulting check image to a point of sales device or ATM via wireless technologies, near field communication (NFC), radio frequency identification (RFID), and other technologies. In other examples, the customer uploads or otherwise sends the check image to the system of process via email, short messaging service (SMS) text, a web portal, online account, mobile applications, and the like. For example, the customer may upload a check image to deposit funds into an account or pay a bill via a mobile banking application using a capture device. The capture device can include any type or number of devices for capturing images or converting a check to any type of electronic format such as a camera, personal computer, laptop, notebook, scanner, mobile device, and/or other device. In some embodiments, the system may receive a paper version of the check and generate an image of the check from the paper version received.

FIG. 5 provides an illustration of an exemplary image of a resource document 300. The resource document illustrated in FIG. 5 is a check. However, one will appreciate that any financial record, financial document, payment instrument, or the like may be provided as a resource document.

The image of check 300 may comprise an image of the entire check, a thumbnail version of the image of the check, individual pieces of check information, all or some portion of the front of the check, all or some portion of the back of the check, or the like. Check 300 comprises check information, wherein the check information comprises contact information 305, the payee 310, the memo description 315, the account number and routing number 320 associated with the appropriate user or customer account, the date 325, the check number 330, the amount of the check 335, the legal tender amount 336, the signature 340, or the like. In some embodiments, the check information may comprise text. In other embodiments, the check information may comprise an image. A capture device may capture an image of the check 300 and transmit the image to a system of a financial institution via a network. The system may store the check information in a datastore as metadata. In some embodiments, the pieces of check information may be stored in the datastore individually. In other embodiments, multiple pieces of check information may be stored in the datastore together.

FIG. 6 illustrates an exemplary template of a resource document 400, in accordance with one embodiment of the present invention. Again, the resource document illustrated in FIG. 6 is a check. However, one will appreciate that any resource document such as a financial record, financial document, payment instruments, or the like may be provided.

In the illustrated embodiment, the check template 400 corresponds to the entire front portion of a check, but it will be understood that the check template 400 may also correspond to individual pieces of check information, portions of a check, or the like. The check template, in some embodiments, includes the format of certain types of checks associated with a bank, a merchant, an account holder, types of checks, style of checks, check manufacturer, and so forth. In some embodiments, check images are standard, such that all fields of the check are within a specifically defined range of locations. As such, the system may utilize these standards to identify the location of information on any given check.

In some embodiments, resource document are categorized by template. The check template 400 is only an exemplary template for a resource document, and other check templates or other financial record templates may be utilized to categorize checks or other financial records. The check template 400 can be used in the OCR processes, image overlay techniques, and the like.

The check template 400 comprises check information, wherein the check information includes, for example, a contact information field 405, a payee line field 410, a memo description field 415, an account number and routing number field 420 associated with the appropriate user or customer account, a date line field 425, a check number field 430, an amount box field 435, a signature line field 440, or the like.

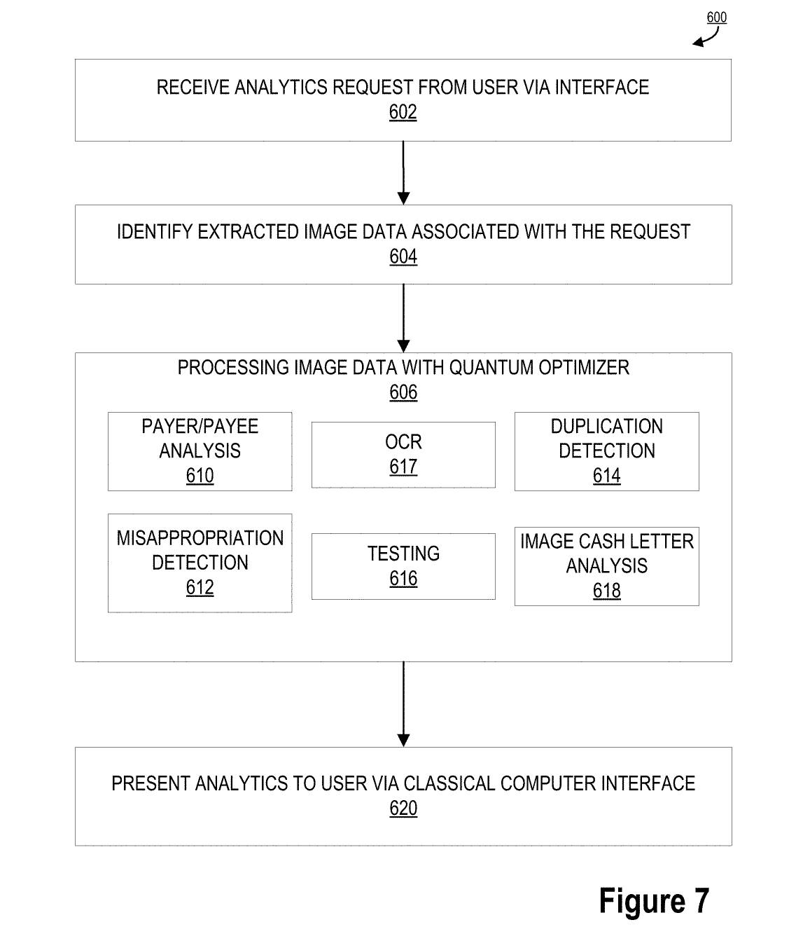

FIG. 7 provides a process flow illustrating advanced correlation of image data 600, in accordance with one embodiment of the present invention. As illustrated in block 602, the process 600 is initiated by receiving an analytics request from a user via a user interface. In this way, the user may utilize a user device or the like to input into a classical computer one or more requests for analysis of the image data extracted from the resource documents. In this way, the user may be able to request payer/payee analysis, additional misappropriation detection for resource documents, identification of resource document duplicate detection, used for testing purposes, and image cash letter analysis from the quantum optimizer via a classical computer input utilizing the coded image data extracted from the paper resource documents.

Next, as illustrated in block 604, the process 600 continues by identifying the appropriate extracted image data associated with the user request. In this way, the system may identify the image data that may be required for the analysis to be complete. As such, the system may select a subsection of the image data such as geographical, age, payee, payor, time frame, or the like. In some embodiments, the quantum optimizer may be able to process all of the image data extracted.

As illustrated in block 606, the process 600 continues by processing the image data with the quantum optimizer. The quantum optimizer may receive the image data from a classical computer. The image data may be processed using qubits within the quantum optimizer to optimize and perform analytics on large amounts of image data. In some embodiments, the processing of the image data with the quantum optimizer 606 may include payer/payee analysis 610, misappropriation detection for resource documents 612, resource document duplicate detection 614, testing purposes 616, OCR processing 617, and/or image cash letter analysis 618.

In some embodiments, the quantum optimizer may perform payer/payee analysis 610. Entities may have billions of check images that are archived every year, the image statement is created the check image data is stored. In some embodiments, the image data is stored upon receipt of the data. The system performs document image processing and utilizes the quantum optimizer for advanced correlation of the image data. For example, the system may perform payer/payee analysis. Thus, the system may identify the use of checks a user drafted, the payee of the checks drafted, and the like and generate a user profile or pattern associated with the user check drafting and receiving. Thus, the system may suggest products/services to the user based on the data analytics performed.

In some embodiments, the quantum optimizer may perform misappropriation detection for resource documents 612. In this way, the system may provide additional misappropriation detection for resource documents. Typically misappropriation detection can include a random search of types of resources that see the most misappropriation and a review of those resource instruments. The system may, using a quantum optimizer, run the image data through an algorithmic misappropriation detection engine against all image data items rather than a select few.

In some embodiments, the quantum optimizer may perform resource document duplicate detection 614. In this way, the system may be utilized for identification of resource document duplicate detection. Historically, duplicate detection has been a very labor intensive process. Situations where there are duplicates require an operator to review. The system may be able to direct the image data to the quantum optimizer to identify duplicates without operator review. For example, the system may review the 1000 ten dollar rebate checks that have the same account and/or serial number and the system may recognize that these are not duplicate checks based on identification of payee and the like that are otherwise not identified by standard OCR systems.

In some embodiments, the quantum optimizer may perform testing purposes 616. In this way, the quantum optimizer could include a scrubber that could clear off user data from a check image, so that a real check could be used for image quality testing and analysis. Using this scrubber would further allow for high volume testing. A scrubber could be built and not be limited to small amounts of data (due to the processing required for the scrub), thus giving the image quality and testing more accurate testing data.

In some embodiments, the quantum optimizer may perform the OCR 617 operations. In some embodiments, standard OCR may not be able to capture all of the data on the resource document including the hand written portions, such as the signature, payee, or the like. In this way, the quantum optimizer to perform the OCR 617 and to extract data.

In some embodiments, the quantum optimizer may perform image cash letter analysis 618. In this way, entities working with resource documents, especially financial institutions receive resource documents that are in transit, or belong to a different issuing institution. The system may be able to scan these outgoing transit resource documents and perform data analytics on them. Using this scan, the quantum optimizer may determine resource document trends for users across multiple entities.

Next, as illustrated in block 620, the process 600 continues by generating and presenting the analytics to the user via a classical computer interface for the user to visualize the analytics.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource document image extraction and advanced correlation of image data, the system comprising:
a classical computer apparatus comprising:
a processor;
a memory; and
a correlation application that is stored in the memory and executable by the processor;
a quantum optimizer in communication with the classical computer apparatus, the quantum optimizer comprising:
a quantum processor; and
a quantum memory;
wherein the correlation application is configured for:
receiving one or more resource documents and perform optical character recognition on the one or more resource documents to generate image data;
storing the generated image data and additional image data;
receiving request for advanced correlation of image data;
identifying image data from the received one or more resource documents necessary for the advanced correlation of image data;
sending a communication to the quantum optimizer for the advanced correlation of image data;
wherein the quantum optimizer is configured for:
performing further optical character recognition to identify and extract the additional image data;
analyzing the image data received from the correlation application to generate the advanced correlation of image data; and
coding the advance correlation for classical computer apparatus receiving and presentation to a user.

2. The system of claim 1, wherein an advanced correlation of image data includes payer/payee analysis, wherein payer/payee analysis includes identifying a use of the one or more resource documents drafted by the payor and generating a payor profile patterning payor use of one or more resource documents and generating suggested financial products or services based on the patterning.

3. The system of claim 1, wherein an advanced correlation of image data includes detection of resource document processing duplicates, wherein detection of resource document processing duplicates comprises the quantum optimizer analyzing the account, serial number, and hand written portions to identify exact duplicates between image data from the one or more resource documents received.

4. The system of claim 1, wherein an advanced correlation of image data includes generating test resource documents for resource document processing, wherein the quantum optimizer includes a scrubber network generates a scrubbed document that clears all data off of a received one or more resource documents except for the background of the document, wherein the scrubbed document is re-positioned in the process with fake information on the scrubbed document for testing the resource document processing.

5. The system of claim 1, wherein an advanced correlation of image data includes generating an image cash letter analysis, wherein the image cash letter analysis includes scanning outgoing transit resource documents and perform data analytics to determine resource document trends for third party payers across multiple entities.

6. The system of claim 1, wherein the correlation application performs optical character recognition on the one or more resource documents including recognition of printed information on the resource documents.

7. The system of claim 1, wherein the quantum optimizer performs further optical character recognition to identify and extract written information from the resource documents, wherein the quantum optimizer identifies and predicts the letters of the written information from the resource documents.

8. The system of claim 1, wherein the request for advanced correlation of image data further comprises a request for payer/payee analysis, misappropriation detection, resource document duplicate detection, testing, or image cash letter analysis.

9. A computer-implemented method for resource document image extraction and advanced correlation of image data, the method comprising:
providing a classical computer system comprising a computer processing device and a non-transitory computer readable medium, where the computer readable medium comprises configured computer program instruction code, such that when said instruction code is operated by said computer processing device, said computer processing device performs the following operations:
receiving one or more resource documents and perform optical character recognition on the one or more resource documents to generate image data;
storing the generated image data and additional image data;
receiving request for advanced correlation of image data;
identifying image data from the received one or more resource documents necessary for the advanced correlation of image data;
sending a communication to the quantum optimizer for the advanced correlation of image data;
providing a quantum optimizer in communication with the classical computer system, wherein the quantum optimizer is configured for:
performing further optical character recognition to identify and extract the additional image data;
analyzing the image data received from the correlation application to generate the advanced correlation of image data; and
coding the advance correlation for classical computer apparatus receiving and presentation to a user.

10. The computer-implemented method of claim 9, wherein an advanced correlation of image data includes payer/payee analysis, wherein payer/payee analysis includes identifying a use of the one or more resource documents drafted by the payor and generating a payor profile patterning payor use of one or more resource documents and generating suggested financial products or services based on the patterning.

11. The computer-implemented method of claim 9, wherein an advanced correlation of image data includes detection of resource document processing duplicates, wherein detection of resource document processing duplicates comprises the quantum optimizer analyzing the account, serial number, and hand written portions to identify exact duplicates between image data from the one or more resource documents received.

12. The computer-implemented method of claim 9, wherein an advanced correlation of image data includes generating test resource documents for resource document processing, wherein the quantum optimizer includes a scrubber network generates a scrubbed document that clears all data off of a received one or more resource documents except for the background of the document, wherein the scrubbed document is re-positioned in the process with fake information on the scrubbed document for testing the resource document processing.

13. The computer-implemented method of claim 9, wherein an advanced correlation of image data includes generating an image cash letter analysis, wherein the image cash letter analysis includes scanning outgoing transit resource documents and perform data analytics to determine resource document trends for third party payers across multiple entities.

14. The computer-implemented method of claim 9, wherein the correlation application performs optical character recognition on the one or more resource documents including recognition of printed information on the resource documents.

15. The computer-implemented method of claim 9, wherein the quantum optimizer performs further optical character recognition to identify and extract written information from the resource documents, wherein the quantum optimizer identifies and predicts the letters of the written information from the resource documents.

16. The computer-implemented method of claim 9, wherein the request for advanced correlation of image data further comprises a request for payer/payee analysis, misappropriation detection, resource document duplicate detection, testing, or image cash letter analysis.

17. A computer program product for resource document image extraction and advanced correlation of image data, the computer program product comprising at least one non-transitory computer-readable medium having computer-readable program code portions embodied therein a classical computer and a quantum optimizer in communication with the classical computer, the classical computer computer-readable program code portions comprising:
an executable portion configured for receiving one or more resource documents and perform optical character recognition on the one or more resource documents to generate image data;
an executable portion configured for storing the generated image data and additional image data;
an executable portion configured for receiving request for advanced correlation of image data;
an executable portion configured for identifying image data from the received one or more resource documents necessary for the advanced correlation of image data;
an executable portion configured for sending a communication to the quantum optimizer for the advanced correlation of image data;
wherein the quantum optimizer is configured for:
an executable portion configured for performing further optical character recognition to identify and extract the additional image data;
an executable portion configured for analyzing the image data received from the correlation application to generate the advanced correlation of image data; and
an executable portion configured for coding the advance correlation for classical computer apparatus receiving and presentation to a user.

18. The computer program product of claim 17, wherein an advanced correlation of image data includes payer/payee analysis, wherein payer/payee analysis includes identifying a use of the one or more resource documents drafted by the payor and generating a payor profile patterning payor use of one or more resource documents and generating suggested financial products or services based on the patterning.

19. The computer program product of claim 17, wherein an advanced correlation of image data includes detection of resource document processing duplicates, wherein detection of resource document processing duplicates comprises the quantum optimizer analyzing the account, serial number, and hand written portions to identify exact duplicates between image data from the one or more resource documents received.

20. The computer program product of claim 17, wherein an advanced correlation of image data includes generating test resource documents for resource document processing, wherein the quantum optimizer includes a scrubber network generates a scrubbed document that clears all data off of a received one or more resource documents except for the background of the document, wherein the scrubbed document is re-positioned in the process with fake information on the scrubbed document for testing the resource document processing.
